(19) United States
(12) Patent Application Publication
(10) Pub. No.: US 2026/0139439 A1
(43) Pub. Date: May 21, 2026

(54) METHOD FOR MANUFACTURING A COMPOSITE FIBRE BOARD

(71) Applicant: ECOR GLOBAL INC, La Jolla, CA (US)

(72) Inventors: Nemanja NIKOLIC, Kraljevo (RS); Dejan VUJOVIC, Kraljevo (RS); Branko BUGARCIC, Backa Palanka (RS)

(21) Appl. No.: 19/113,638

(22) PCT Filed: Aug. 29, 2023
(86) PCT No.: PCT/IB2023/058528

§ 371 Date: Mar. 20, 2025

(30) Foreign Application Priority Data
Sep. 23, 2022 (NL) 2033117

(51) Int. Cl. D21J 1/04; B27N 1/00; B27N 3/00; B27N 3/04; B27N 3/18; E04C 2/16

(52) U.S. Cl. CPC D21J 1/04; B27N 1/003; B27N 3/002; B27N 3/007; B27N 3/04; B27N 3/18; E04C 2/16

(57) ABSTRACT

The present invention relates to a method for manufacturing a composite fibre board and to a composite fibre board thus obtained. The present invention furthermore relates to a laminate comprising a stack of composite fibre boards, as well to its use. An object of the present invention is thus to provide an advanced environmentally sustainable composite board as an alternative for wood-based products.

### DESCRIPTION

The present invention relates to a method for manufacturing a composite fibre board and to a composite fibre board thus obtained. The present invention furthermore relates to a laminate comprising a stack of composite fibre boards, as well to its use.

A method for manufacturing a composite fibre board is known in the art.

For example, International application WO2007020657 discloses a process for manufacturing a composite material component comprising a step of forming a slurry with resin solution, fillers and optional additives, a step of impregnation, spraying, coating of bamboo and jute provided separately or combined in a ratio of 1:99 to 99:1 mixture of resin, additives and filler into the slurry with or without other natural fibres selected from Bulrush (Hogla), Hem, Banana and pine apple, in amount of 1%-90% by wt. of reinforcement material when present, a step of drying the impregnated/sprayed/coated reinforcement material in oven at temperature of 50° C. to 200° C. and cutting the impregnated/sprayed/coated and dried fibres or panels into required size and a step of pressing the impregnated/sprayed/coated dried cut pieces of bamboo and jute with or without the other natural fibres multi-layered according to require thickness and pressed in the hydraulic press at a pressure 0.1 to 20 tons per square inches for a definite period at a defined temperature.

GB1435195A discloses a method of manufacturing a laminate sheet, wherein a wood veneer is covered on one side only with a layer of a polymer which is bonded to the veneer by heating under pressure, and the veneer is then bonded by glueing on its uncoated side to a wood substrate, wherein the veneer is covered with the polymer at a temperature of between 140-170° C. at a pressure of 440 kgf/cm² for 15-30 minutes.

CN 108797192 relates to a glue-free straw fiber board, which is prepared by hot-pressing a wet billet obtained by uniformly mixing straw fibers and auxiliary materials, wherein the mass fraction of the straw fibers is 20% to 80%, and the balance is auxiliary materials selected from one or more of wood fiber, bamboo fiber and chemical fiber. The preparation method of the glue-free straw fiberboard comprises a step of expanding the straw in an extruder to obtain straw fibers, a step of mixing the straw fiber with water to obtain a straw fiber slurry, a step of pulping the straw fiber slurry with auxiliary materials, wherein the suspension obtained by pulping is made into a wet billet by the drawing method comprising dehydration, filtration and compacting. When the wet billet reaches the required thickness, it is transferred from the forming cylinder to a hot press machine operating at a temperature of 180-220° C. to produce a glue-free straw fiberboard.

The Sustainable Development Goals (SDGs), also known as the Global Goals, were adopted by the United Nations in 2015 as a universal call to action to end poverty, protect the planet, and ensure that by 2030 all people enjoy peace and prosperity. There is no country that is not experiencing the drastic effects of climate change. Greenhouse gas emissions are more than 50 percent higher than in 1990. Global warming is causing long-lasting changes to our climate system, which threatens irreversible consequences if we do not act.

Material from paper industry material, such as old, corrugated cardboard (OCC), office paper, newspaper, silicon coated paper (SCP) is nowadays collected and recycled as starting material for making new paper and cardboard. Waste from other industries, such as spent brewers'grains (SBG), spent coffee ground (SCG), egg husks can be converted into a feed additive for animals. Furthermore, it is known to develop products from agricultural waste, such as light wallboards made by heat compression of rice straw and shell corn as raw material and adhesives and synthetic urea Fort Thomas aldehyde 13% acting as adhesives.

An object of the present invention is thus to provide an advanced environmentally sustainable composite board as an alternative for wood-based products.

Another object of the present invention is to provide a method for manufacturing a composite fibre board wherein a plurality of its components are natural based components and/or recycled components.

Another object of the present invention is to provide a composite fibre board that has a high dimensional level of stability and flatness.

The present invention as mentioned above relates to method for manufacturing a composite fibre board via thermopressing, the method comprising the steps of:
i) providing a mixture of raw materials comprising fibres,
ii) thermopressing the mixture of a) in a temperature range of 120° C. to 210° C., a pressure in a range from 3 to 200 kg/cm2 and a reaction time from 1 to 20 minutes,
wherein the raw material mixture comprises 0-35 wt. % silicone coated paper and 65-100 wt. % agricultural materials, based on the total weight of the raw material mixture.

The present inventors found that one or more of the above objects can be achieved by providing a specific mixture of raw materials comprising fibres, especially comprising 0-35 wt. % silicone coated paper and 65-100 wt. % agricultural materials. The present inventors were able to provide a method for manufacturing a composite fibre board via thermopressing wherein the mixture of raw materials is recyclable, biobased, sustainable, environmentally friendly and/or biodegradable.

In an example the agricultural materials are chosen from the group of wheat straw, corn straw or silage, rice straw, cotton, hemp, kenaf, sugarcane bagasse, bamboo, soya straw, miscanthus, rapeseed straw, sunflower straw, agave, and other fibres resulting from underutilized or waste streams as a result of agri-business or manufacturing processes, such as coffee grounds, nut shells, husks, and eggshells, or a combination thereof. This means that the present method for manufacturing a composite fibre board may be conducted by a mixture of several types of straw, such as straw originating from soya, hemp, and wheat. The lower range of 0 wt. % for the silicone coated paper means that the present method for manufacturing a composite fibre board may be carried out without any silicone coated paper, but preferred embodiments relate to at least 1 wt. % of silicone coated paper, preferably at least 5 wt. % of silicone coated paper, more preferably 15 wt. % of silicone coated paper, based on the total weight of the raw material mixture.

In an example the raw material mixture further comprises 1-35 wt. % natural paper based cellulose fibres chosen from the group of recycled cardboard, recycled craft or kraft paper, recycled office paper, and recycled newsprint, or a combination thereof, based on the total weight of the raw material mixture.

Once the mixture has been formed, preferably, the resulting mixture has a solids content of between 50 wt. % and 80 wt. %. An amount lower than 50 wt. % may result in technical problems during the thermopressing stage, such as maintaining the mixture in a stable position in the press. An amount of more than 80 wt. % may result in a less easily formable mixture in the thermopressing stage.

In an example the fibres of the mixture of raw materials have a length equal to or less than 1.2 mm, and more preferably equal to or less than 1.0 mm, and more preferably equal to or less than 0.8 mm. A length of the fibre in such a range will lead to strong network of fibers resulting in a dimensional stable final product.

The present invention furthermore relates to a composite fibre board obtained according to a method as discussed above and having a thickness of 0,5-50 mm and a density of 300-1100 kg/m³.

In an example of a composite fibre board obtained according to a method as discussed above the formaldehyde emission as tested under ASTM D6007 using analytical method ASTMD5197 renders an emission standard of less than 0.01 ppm, preferably less than 0.007 ppm and more preferably less than 0.006 ppm.

The present invention furthermore relates to a laminate comprising a stack of composite fibre boards as discussed above, wherein the composite fibre boards are laminated using a polyvinyl acetate based adhesive.

In another example the present invention relates to a laminate comprising a stack of composite fibre boards as discussed above, wherein the composite fibre boards are laminated using an adhesive not containing any formaldehyde or formaldehyde derivatives.

In an example of a laminate the formaldehyde emission as tested under ASTM D6007 using analytical method ASTMD5197 renders an emission standard of less than 0.01 ppm, preferably less than 0.005 ppm and more preferably less than 0.004 ppm.

The present invention also relates to the interior and/or exterior use of a composite board as discussed above or a laminate as discussed above as a construction material chosen from the group of flooring, furniture, wall coverings, facades, and ceilings.

In an embodiment of flooring application the thickness swelling and click tensile strength of the final panel is ≤12% and ≥500N, respectively.

In an example of the method for manufacturing a composite fibre board via thermopressing existing machines and equipment from paper milling industry and existing machines for harvesting and milling agricultural products were used and combined in order to achieve proper blended mixture of raw materials. By this way fibres from raw material are processed to proper size, especially ≤1,2 mm. In further process, by proper process conditions such as heat, especially 160-210° C., and pressure, especially 3-200 kg/cm²) and time, especially 1-20 min, the process of activating of lignin from the fibres is initiated and the activated lignin can be seen as a natural glue.

The thickness of the manufactured board is in a range of 0,5-50 mm and the density is in a range of 300-1100 kg/m³.

The final laminate may contain additional components, such as flame retardants, plasticizers, pigments, dyes, fillers, emulsifiers, surfactants, thickeners, rheology modifiers, heat, and radiation stabilization additives, defoamers, levelling agents, anti-cratering agents, fillers, sedimentation inhibitors, U.V. absorbers, and antioxidants.

In order to further understand the techniques, means and effects of the present disclosure, the following detailed descriptions and examples are hereby referred to, such that, and through which, the purposes, features and aspects of the present disclosure can be thoroughly and concretely appreciated; however, the appended examples are merely provided for reference and illustration, without any intention to be used for limiting the present disclosure. In the examples the abbreviation OCC means: Old Corrugated Containers according to EN 643, SCP means-Silicone Coated Paper, also known as a “release liner”, WOP means waste office paper.

### EXAMPLES 1-10 AND COMPARATIVE EXAMPLES 11-12

### Example 1

A mixture of raw materials was prepared. The mixture comprising 30 wt. % soya, 30 wt. % wheat and 30 wt. % hemp and 5 wt. % OCC, 5 wt. % SCP. The mixture was milled and the raw materials size was ≤1mm. The total solid content of the mixture before pressing was 60%. The process conditions for manufacturing a composite fibre board were: T=200° C.; P=7 kg/cm²; t=365 s.

The thickness of composite fibre board (medium density fiberboard) thus obtained was 3 mm having a density of 712kg/m³. The board having a smooth and even surface was dimensional stable and flat.

### Example 2

A mixture of raw materials was prepared. The mixture comprising 85 wt. % soya and 15 wt. % SCP. The mixture was milled, and the raw materials size was ≤0.8 mm. The total solid content of the mixture before pressing was 50%. The process conditions for manufacturing a composite fibre board were: T=200° C.; P=14kg/cm²; t=310 s.

The thickness of composite fibre board (high density fibreboard) thus obtained was 2 mm having a density of 907kg/m³. The board having a smooth and even surface was dimensional stable and flat.

### Example 3

A mixture of raw materials was prepared. The mixture comprising 65 wt. % Miscanthus and 35 wt. % SCP. The mixture was milled, and the raw materials size was ≤1.2 mm. The total solid content of the mixture before pressing was 70%. The process conditions for manufacturing a composite fibre board were: T=200° C.; P=3kg/cm²; t=1190 s.

The thickness of composite fibre board (low density fibreboard) thus obtained was 20 mm having a density of 392kg/m³. The board having a smooth and even surface was dimensional stable and flat.

### Example 4

A mixture of raw materials was prepared. The mixture comprising 30 wt. % Miscanthus, 30 wt. % OCC, 30 wt. % SCP and 10 wt. % spent brewers'grain. The mixture was milled, and the raw materials size was ≤0.9 mm. The total solid content of the mixture before pressing was 50%. The process conditions for manufacturing a composite fibre board were: T=180° C.; P=13 kg/cm²; t=540 s.

The thickness of composite fibre board (high density fibreboard) thus obtained was 2.5 mm having a density of 874kg/m³. The board having a smooth and even surface was dimensional stable and flat.

### Example 5

A mixture of raw materials was prepared. The mixture comprising 50 wt. % wheat, 30 wt. % rapeseed, 10 wt. % SCP and 10 wt. % waste office paper. The mixture was milled, and the raw materials size was ≤1.1 mm. The total solid content of the mixture before pressing was 50%. The process conditions for manufacturing a composite fibre board were: T=200° C.; P=14 kg/cm²; t=370 s.

The thickness of composite fibre board (high density fibreboard) thus obtained was 3.5 mm having a density of 897kg/m³. The board having a smooth and even surface was dimensional stable and flat.

### Example 6

A mixture of raw materials was prepared. The mixture comprising 60 wt. % miscanthus, 20 wt. % OCC, 10 wt. % SCP and 10 wt. % spent coffee ground. The mixture was milled, and the raw materials size was ≤1.0 mm. The total solid content of the mixture before pressing was 50%. The process conditions for manufacturing a composite fibre board were: T=150° C.; P=12 kg/cm²; t=355 s.

The thickness of composite fibre board (high density fibreboard) thus obtained was 2.1 mm having a density of 823 kg/m³. The board having a smooth and even surface was dimensional stable and flat.

### Example 7

A mixture of raw materials was prepared. The mixture comprising 40 wt. % soya, 35 wt. % wheat, 10 wt. % hemp, 5 wt. % SCP and 5 wt. % cocoa shells and 5 wt. % peanut husks. The mixture was milled, and the raw materials size was ≤1.2 mm. The total solid content of the mixture before pressing was 50%. The process conditions for manufacturing a composite fibre board were: T=210° C.; P=14 kg/cm²; t=600 s.

The thickness of composite fibre board (high density fibreboard) thus obtained was 3.5 mm having a density of 918 kg/m³. The board having a smooth and even surface was dimensional stable and flat.

### Example 8

A mixture of raw materials was prepared. The mixture comprising 50 wt. % soya, 20 wt. % wheat, 20 wt. % corn, and 10 wt. % SCP. The mixture was milled, and the raw materials size was ≤1.2 mm. The total solid content of the mixture before pressing was 50%. The process conditions for manufacturing a composite fibre board were: T=200° C.; P=14 kg/cm²; t=360 s.

The thickness of composite fibre board (high density fibreboard) thus obtained was 3.2 mm having a density of 885 kg/m³. The board having a smooth and even surface was dimensional stable and flat.

### Example 9

A panel was manufactured by laminating four individual layers according to the invention (medium density fiberboard MDF having a thickness of 2.5 mm and a density of 730 kg/m³ ) and using polyvinyl alcohol (Vinavil 2252M) as an adhesive. The lamination conditions were: T=90° C.; P=7 kg/cm² and t=200 s. The board characteristics thus obtained are a thickness of 10 mm and a density of 730 kg/m³.

The thickness of composite fibre board (medium density fibreboard) thus obtained was 10.0 mm having a density of 730kg/m³.

Both individual layers and laminated board are MDF (medium density fibreboard). The laminated board having a smooth and even surface was dimensional stable and flat.

### Example 10

A panel was manufactured by laminating five individual layers according to the invention (high density fiberboard HDF having a thickness of 2.0 mm and a density of 907 kg/m 3 ) and using polyvinyl alcohol (Kleiberit 303.0) as an adhesive. The lamination conditions were: T=85° C.; P=14 kg/cm² and t=240 s.

The board characteristics of composite fibre board thus obtained are a thickness of 10 mm and a density of 907 kg/m³.

Both individual layers and laminated board are HDF (high density fiberboard). The laminated board having a smooth and even surface was dimensional stable and flat.

### Comparative example 11

A mixture of raw materials was prepared. The mixture comprising 60 wt. % Miscanthus and 40 wt. % SCP. The mixture was milled, and the raw materials size was ≤1.2 mm. The total solid content of the mixture before pressing was 60%. The process conditions for manufacturing a composite fibre board were: T=200° C.; P=7 kg/cm²; t=360 s.

The thickness of composite fibre board (medium density fibreboard) thus obtained was 2.7 mm having a density of 711 kg/m 3 .

During experimental testing, the inventors found that over 35% of silicone coated paper in product recipe leads to a severe damage of the board. The outer most surface of the fibreboard showed delamination issues. With more than 35% of silicone coated paper in the product recipe it is not possible to have stable production and quality.

### Comparative Example 12

A mixture of raw materials was prepared. The mixture comprising 30 wt. % soya, 30 wt. % wheat, 30 wt. % hemp and 5 wt. % OCC and 5 wt. % SCP. The mixture was milled, and the raw materials size was ≤1.0 mm. The total solid content of the mixture before pressing was 60%. The process conditions for manufacturing a composite fibre board were: T=220° C.; P=7 kg/cm²; t=420 s.

The thickness of composite fibre board (medium density fibreboard) thus obtained was 3.0 mm having a density of 702 kg/m³.

The temperature during the step over thermopressing was too high resulting in a fibre board having a rough and uneven surface provided with bubbles. The inventors indicated these conditions as “overcooked”. The composite fibre board is dimension unstable and cannot be used for interior and/or exterior use.

The composite fiberboard of Example 1 was tested for formaldehyde emissions according to California Air Resources Board (CARB) Phase 2 formaldehyde emission standards as published in Final Regulation Order, Airborne Toxic Control Measure to Reduce Formaldehyde Emissions from Composite Wood Products, Section 93120.2 Table 1, Title 17, California Code of Regulations. The emission standards are standardized chamber concentrations for composite wood core materials measured by primary method ASTM Standard Method E-1333. Secondary test method ASTM Standard Method D6007 has been shown to produce equivalent results. The measured formaldehyde chamber concentration and the concentration adjusted to standard conditions of 25° C. and 50% relative humidity are 0.004 ppm and 0.006 ppm, respectively. These values meet the Phase 2 Emission Standard (ppm), i.e. Regulatory Requirements.

The laminated composite fiberboard according to Example 10 was tested for formaldehyde emissions according to The California Air Resources Board (CARB) Phase 2 formaldehyde emission standards as published in Final Regulation Order, Airborne Toxic Control Measure to Reduce Formaldehyde Emissions from Composite Wood Products, Section 93120.2 Table 1, Title 17, California Code of Regulations. The emission standards are standardized chamber concentrations for composite wood core materials measured by primary method ASTM Standard Method E-1333. Secondary test method ASTM Standard Method D6007 has been shown to produce equivalent results. The measured formaldehyde chamber concentration and the concentration adjusted to standard conditions of 25° C. and 50% relative humidity are 0.006 ppm and 0.004 ppm, respectively. These values meet the Phase 2 Emission Standard (ppm), i.e. Regulatory Requirements.

1. A method for manufacturing a composite fibre board via thermopressing, the method comprising the steps of:
i) Providing a mixture of raw materials comprising fibres,
ii) Thermopressing the mixture of a) in a temperature range of 120° C. to 210° C., a pressure in a range from 3 to 200 kg/cm ² and a reaction time from 1 to 20 minutes, wherein the raw material mixture comprises 0-35 wt. % silicone coated paper and 65-100 wt. % agricultural materials, based on the total weight of the raw material mixture.

2. A method according to claim 1, wherein the agricultural materials are chosen from the group of wheat straw, corn straw or silage, rice straw, cotton, hemp, kenaf, sugarcane bagasse, bamboo, soya straw, miscanthus, rapeseed straw, sunflower straw, agave, and other fibres resulting from underutilized or waste streams as a result of agri-business or manufacturing processes, such as coffee grounds, nut shells, husks, and eggshells, or a combination thereof.

3. A method according to claim 1, wherein the raw material mixture further comprises 1-35 wt. % natural paper based cellulose fibres chosen from the group of recycled cardboard, recycled craft or kraft paper, recycled office paper, and recycled newsprint, or a combination thereof, based on the total weight of the raw material mixture.

4. A method according to claim 1, wherein the solids content of the mixture of i) is between 50% and 80% before the step of thermopressing.

5. A method according to claim 1, wherein the raw material mixture comprises at least 1 wt. % of silicone coated paper, preferably at least 5 wt. % of silicone coated paper, more preferably 15 wt. % of silicone coated paper, based on the total weight of the raw material mixture.

6. A method according to claim 1, wherein the fibres of the mixture of raw materials comprising fibres have a length equal to or less than 1.2 mm, and more preferably equal to or less than 1.0 mm, and more preferably equal to or less than 0.8 mm.

7. A method according to claim 1, wherein the manufactured composite fibre board is obtained according to the steps having a thickness of 0,5-50 mm and a density of 300-1100 kg/m³.

8. A method according to claim 7, wherein wherein the formaldehyde emission as tested under ASTM D6007 using analytical method ASTMD 5197 renders an emission standard of less than 0.01 ppm, preferably less than 0.007 ppm and more preferably less than 0.006 ppm.

9. A laminate comprising a stack of composite fibre boards manufactured according claim 7, wherein the composite fibre boards are laminated using a polyvinyl acetate based adhesive.

10. A laminate comprising a stack of composite fibre boards manufactured according to claim 7, wherein the composite fibre boards are laminated using an adhesive not containing any formaldehyde or formaldehyde derivatives.

11. A laminate according to claim 10, wherein the formaldehyde emission as tested under ASTM D6007 using analytical method ASTMD5197 renders an emission standard of less than 0.01 ppm, preferably less than 0.005 ppm and more preferably less than 0.004 ppm.

12. A method according to claim 7, wherein the manufactured composite fibre board is manufactured as a construction material chosen from the group of flooring, furniture, wall coverings, facades, and ceilings for interior and exterior use.

13. A laminate according to claim 9, wherein the laminate is formed as a construction material chosen from the group of flooring, furniture, wall coverings, facades, and ceilings for interior and exterior use.
